(19) United States
(12) Patent Application Publication
(10) Pub. No.: US 2005/0044663 A1
(43) Pub. Date: Mar. 3, 2005

(54) Freely adjustable hinge device for foldable electronic device

(75) Inventors: Feng Wu, Shenzhen (CN); Shi-Hua Tian, Shenzhen (CN); Sheng-Ke Jiang, Shenzhen (CN); Sheng-Cheng Hsu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-cheng City (TW)

(21) Appl. No.: 10/892,076

(22) Filed: Jul. 15, 2004

(30) Foreign Application Priority Data
Aug. 27, 2003 (TW) 92215476

(51) Int. Cl. E05F 1/14

(52) U.S. Cl. 16/280

(57) ABSTRACT

A hinge device includes a driven block (3), a cam (4), and a spring (7). The driven block includes two protrusions (31) projecting upwardly and downwardly respectively, the cam defines two opposite concave grooves (41) and two opposite arms (42), and the spring presses the driven block and the cam. Interfaces of the driven block (3) and the arms of the cam are plane surfaces, so that when the protrusions of the driven block are located on the plane surfaces, the hinge device is held in a steady state by the spring.

### BACKGROUND OF THE INVENTION

1. Field of the Invention

The present invention relates to hinge devices, and particularly to a hinge device for foldable electronic devices such as portable telephones, portable computers, and so on.

2. Description of the Prior Art

Conventionally, a body and a cover of a foldable electronic device are connected by a hinge device. One such kind of hinge device is disclosed in U.S. Pat. No. 6,175,990 and represented in FIG. 6 herein. The hinge device includes a pin 10, a fixing member 20, a fixed cam 30, a rotary sliding cam 40, and a compression spring 50. The pin 10 comprises a keyed shaft 104, and a flange head 102 at one end of the keyed shaft 104. The fixing member 20 defines a keyed hole 202, the fixed cam 30 defines a circular hole 304, and the rotary sliding cam 40 defines a keyed hole 404. The keyed shaft 104 is inserted through the holes 304, 404, 202. A pair of opposite recessed cam portions 302 is defined on an end face of the fixed cam 30. A pair of opposite projection portions 402 is formed on an end face of the rotary sliding cam 40, corresponding to the cam portions 302.

In assembly, the keyed shaft 104 of the pin 10 is inserted through the circular hole 304, until the fixed cam 30 lockingly abuts the flange head 102 of the pin 10. The keyed shaft 104 is inserted through the keyed hole 404 of the rotary sliding cam 40. The compression spring 50 is disposed around the keyed shaft 104 so that an end of the compression spring 50 abuts an end of the rotary sliding cam 40. The keyed shaft 104 is inserted through the keyed hole 202, so that it abuts and biases an opposite end of the compression spring 50. Thus the rotary sliding cam 40 is slidable along an axial direction of the keyed shaft 104 between the fixed cam 30 and the fixing member 20, and is also rotatable with the pin 10 relative to the fixed cam 30. Furthermore, the compression spring 50 is elastically engaged around the pin 10 between the rotary sliding cam 40 and the fixing member 20, and continually presses the rotary sliding cam 40 against the fixed cam 30.

When the projection portions 402 of the rotary sliding cam 40 are engaged with the cam portions 302 of the fixed cam 30, the foldable electronic device is closed. When the foldable electronic device is opened, the projection portions 402 move out from engagement with the cam portions 302 onto coplanar end faces of the fixed cam 30. Once the foldable electronic device is opened to an angle of about 180°, the projection portions 402 snappingly engage into corresponding of the cam portions 302 and are locked therein. The foldable electronic device cannot be opened to any angle other than 180°, because the projection portions 402 do not stably engage on the coplanar end faces of the fixed cam 30. In addition, the projection portions 402 of the rotary sliding cam 40 are designed with relatively sharp edges and corners, which are prone to be worn smooth after repeated use. When this happens, the connection between the body and the cover is liable to become loose.

An improved hinge device which allows variable opening of the cover of a foldable electronic device to a range of different angles is desired.

### SUMMARY OF THE INVENTION

Accordingly, an object of the present invention is to provide a hinge device that enables a cover of a foldable electronic device to be opened and held in place at any angle relative to a body of the foldable electronic device.

A hinge device of the present invention comprises a driven block having two protrusions projecting in opposite directions, a cam defining two opposite concave grooves and two opposite arms, and a spring for pressing the driven block and the cam. Interfaces of the driven block and the arms of the cam are plane surfaces, so that when the protrusions of the driven block are located on the plane surfaces, the hinge device is held in a steady state by the spring.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a hinge device in accordance with a preferred embodiment of the present invention;

FIG. 2 is an enlarged, assembled view of the hinge device of FIG. 1, but viewed from another aspect, and showing the hinge device in a first state in which a cam of a base block is engaged with a driven block of a sleeve;

FIG. 3 is a cross-sectional view taken along line III-III of FIG. 2;

FIG. 4 is similar to FIG. 2, but showing the hinge device in a second state, in which the base block and the sleeve have been rotated 90° relative to each other;

FIG. 5 is a cross-sectional view taken along line V-V of FIG. 4; and

FIG. 6 is an exploded, isometric view of a hinge device of the prior art.

### DETAILED DESCRIPTION OF THE INVENTION

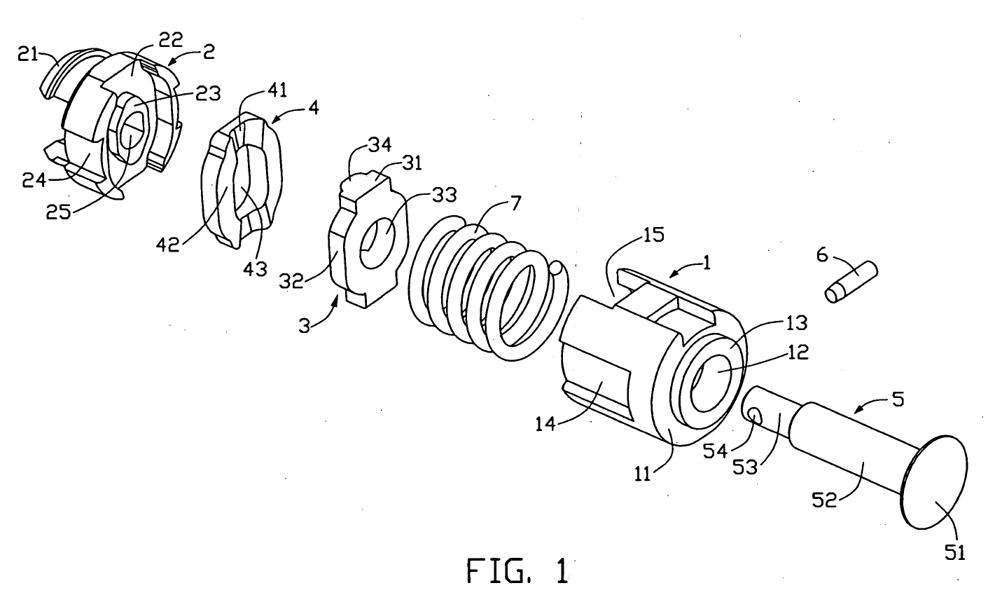

Referring to FIG. 1, a hinge device of the present invention includes a sleeve 1, a base block 2, a driven block 3, a cam 4, a shaft 5, a pin 6 and a spring 7. The spring 7 and the driven block 3 are received in the sleeve 1, the cam 4 is received in the base block 2, the shaft 5 passes through the sleeve 1, the spring 7, the driven block 3, the cam 4 and the base block 2, and the pin 6 is received through a pinhole 54 of the shaft 5 in order to fix the whole structure of the hinge device.

The sleeve 1 is made of plastic and is generally cylindrical. One end of the sleeve 1 is open, and an opposite end of the sleeve 1 is partially closed off by an end portion 11. An aperture 12 is defined in the end portion 11, and a flange 13 extends outwardly from the edge of the aperture 12. A plurality of engaging grooves 14 is defined in an outside circumferential wall of the sleeve 1, for engagingly receiving a plurality of protrusions (not shown) of a cover of a foldable electronic device of the present invention. Thus, the sleeve 1 can rotate together with the cover. Two opposite latch openings 15 are defined through the circumferential wall of sleeve 1 at the open end thereof.

The driven block 3 includes two protrusions 31 projecting upwardly and downwardly respectively, two plane sides 32, and a through hole 33. The protrusions 31 are dimensioned to correspond to the latch openings 15, and a length of each plane side 32 is less than an internal diameter of the sleeve 1. Thus, the driven block 3 can be engaged in the sleeve 1, and can move along an axis of the sleeve 1. A distal extremity of each protrusion 31 defines a plane 34, with one end of the plane 34 being generally arcuate.

The cam 4 is generally annular, and includes two opposite concave grooves 41, two opposite plane arms 42, and a through hole 43.

The base block 2 is generally cylindrical. A fixed pole 21 extends outwardly from one end of the base block 2. The fixed pole 21 can be engaged with a body of the foldable electronic device, thereby fixing the hinge device to the foldable electronic device. A groove 22 is defined in an opposite end of the base block 2, with a positioning block 23 being defined in part of a middle portion of the groove 22. Thus the groove 22 is shaped and dimensioned to correspond to the cam 4, with the positioning block 23 shaped and dimensioned to correspond to the through hole 43 of the cam 4. Accordingly, the cam 4 can be received in the base block 2, so that it moves together with the base block 2. A plurality of positioning grooves 24 is defined in an outside circumferential wall of the base block 2, for engagingly receiving a plurality of protrusions (not shown) of the body of the foldable electronic device. A through hole 25 is defined through a center of the base block 2.

The shaft 5 comprises a main body 52, a flange head 51 at one end of the main body 52, and an end portion 53 extending coaxially from an opposite end of the main body 52. The end portion 53 has a smaller diameter than that of the main body 52, and corresponds to the through hole 25 of the base block 2. The pinhole 54 is defined through a distal end section of the deformed shaft 53.

The pin 6 is generally cylindrical, with one end thereof tapered for convenient insertion of the pin 6 into the pinhole 54. The pin 6 is longer than a length of the pinhole 54.

In assembly, the spring 7 is received in the sleeve 1. The driven block 3 is received in the sleeve 1, with the protrusions 31 being received in the latch openings 15 and thereby restricting movement of the driven block 3. The cam 4 is received in the base block 2, with the plane arms 42 being received in the groove 22, and the positioning block 23 being received in the through hole 43. The shaft 5 is inserted through the sleeve 1, the spring 7, the driven block 3, the cam 4 and the base block 2 in turn. Finally, the pin 6 is inserted into the pinhole 54, thereby fixing the whole structure of the hinge device.

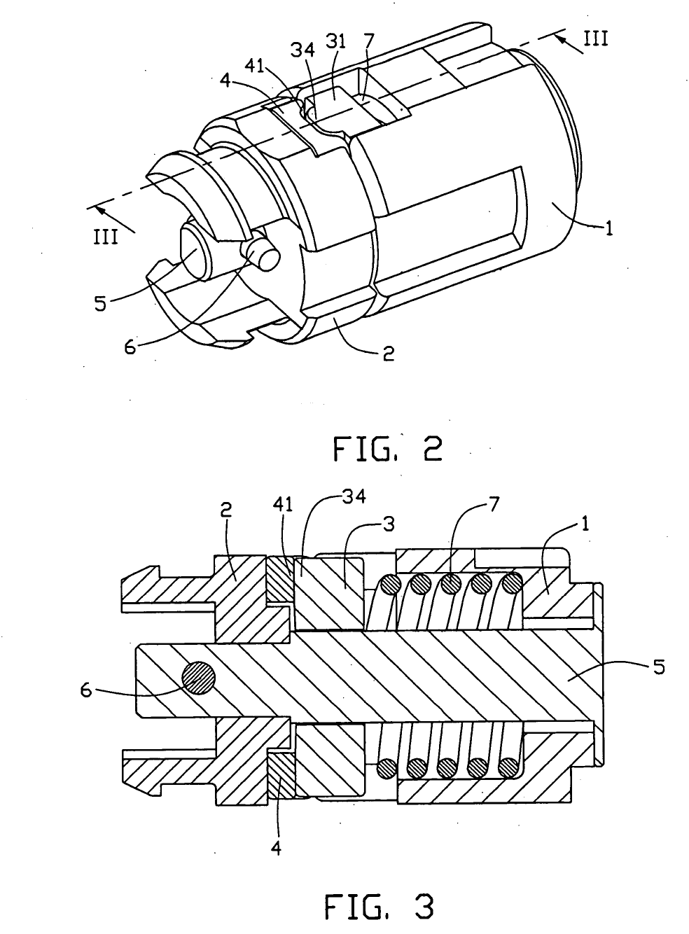

Referring to FIGS. 2 and 3, when the protrusions 31 are located in the concave grooves 41 of the cam 4, the driven block 3 and the cam 4 are securely engaged with each other. This position corresponds to the cover being closed relative to the body of the foldable electronic device. The spring 7 is only slightly compressed, and its elastic potential energy is weakest.

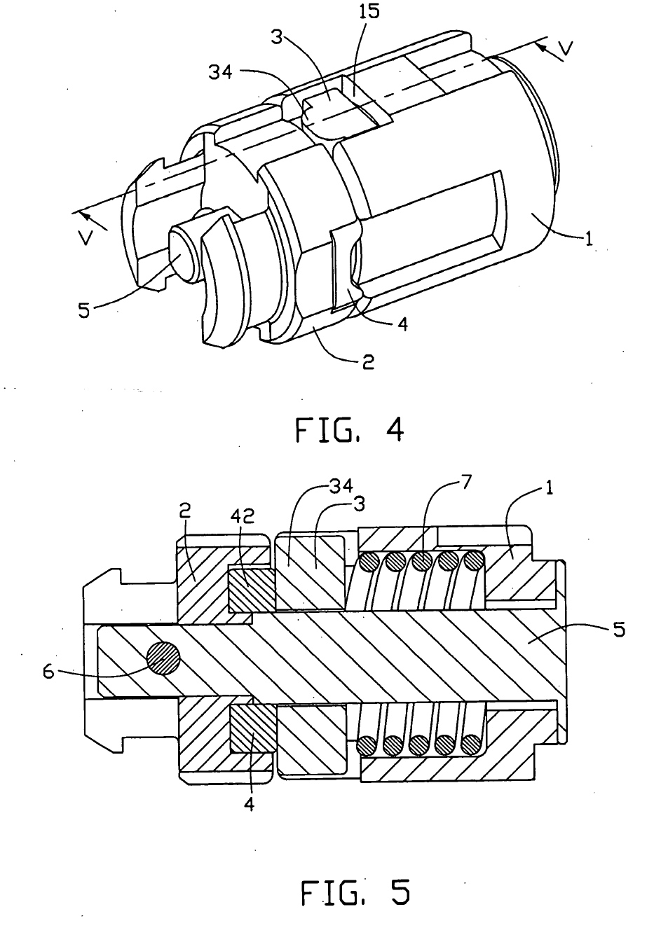

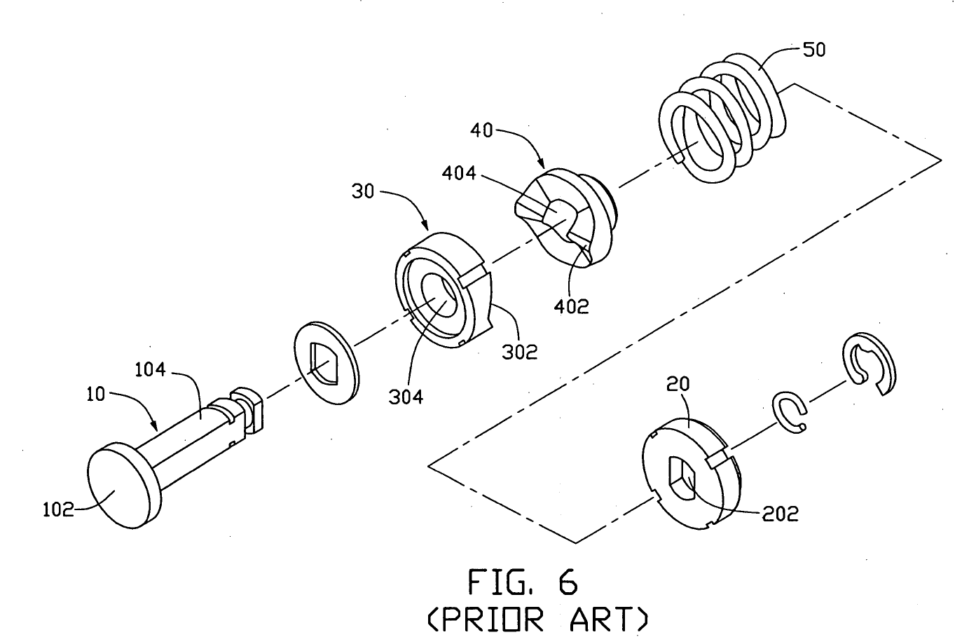

Referring to FIGS. 4 and 5, when the sleeve 1 is rotated relative to the base block 2, the protrusions 31 of the driven block 3 are rotated out from the concave grooves 41 to slide along the plane arms 42 of the cam 4. This is because the protrusions 31 are rotationally immovable in the latch openings 15, and because the plane arms 42 of the cam 4 are fixed in the groove 22 of the base block 2. As the protrusions 31 are rotated out from the concave grooves 41 to slide along the plane arms 42, the driven block 3 is also driven to move along the axis of the sleeve 1 and to further compress the spring 7. The elastic potential energy of the spring 7 is now strongest, so that the sleeve 1 can be stopped in any desired position, with the protrusions 31 biasedly engaged on the plane arms 42. If the sleeve 1 is rotated 180° relative to the base block 2, the protrusions 31 are engagingly received in corresponding of the concave grooves 41. This position corresponds to the cover being fully open relative to the body of the foldable electronic device.

In summary, the unique advantage of the hinge device of the present invention is that the sleeve 1 and the base block 2 can be held in any position relative to each other, so that the cover of the foldable electronic device of the present invention can be held at any position relative to the body.

Although the present invention has been described with specific terms, it should be noted that the described embodiment is not necessarily exclusive, and that various changes and modifications may be made thereto without departing from the scope of the present invention as defined in the appended claims.

1. A hinge device, comprising:
a driven block comprising two protrusions thereon, the two protrusions protruding in opposite directions;
a cam defining two opposite concave grooves and two opposite arms; and
a spring for pressing the driven block and the cam; wherein
interfaces of the driven block and the arms of the cam are plane surfaces, and when the protrusions of the driven block are located on the plane surfaces, the hinge device is held in a steady state by the spring.

2. The hinge device as described in claim 1, further comprising a shaft received through the driven block, the cam and the spring.

3. The hinge device as described in claim 2, wherein the shaft comprises a main body, a flange head at one end of the main body, and an end portion extending coaxially from an opposite end of the main body.

4. The hinge device as described in claim 3, wherein said end portion has a smaller diameter than that of the main body, and a distal end section of said end portion defines a pinhole therethrough.

5. The hinge device as described in claim 4, further comprising a pin received in the pinhole.

6. The hinge device as described in claim 1, further comprising a sleeve received in the driven block.

7. The hinge device as described in claim 6, wherein the sleeve is cylindrical, with one end thereof open and an opposite end thereof partially closed.

8. The hinge device as described in claim 7, wherein said opposite end of the sleeve defines an aperture therein, and a flange extends outwardly from an edge of the aperture.

9. The hinge device as described in claim 8, wherein a circumferential wall of the sleeve defines a plurality of engaging grooves therein.

10. The hinge device as described in claim 9, wherein the circumferential wall of the sleeve at said open end thereof defines two opposite latch openings.

11. The hinge device as described in claim 10, wherein the protrusions of the driven block are dimensioned according to the latch openings, a length of each of plane sides of the driven block is less than an internal diameter of the sleeve, a distal extremity of each protrusion defines a plane, with one end of said plane being generally arcuate.

12. The hinge device as described in claim 1, further comprising a base block receiving the cam.

13. The hinge device as described in claim 12, wherein a fixing member extends outwardly from one end of the base block.

14. The hinge device as described in claim 13, wherein a groove is defined in an opposite end of the base block, with a positioning block being provided in part of a middle portion of said groove.

15. The hinge device as described in claim 14, wherein the groove is shaped and dimensioned to correspond to the cam, and the positioning block is shaped and dimensioned to correspond to the through hole of the cam.

16. The hinge device as described in claim 15, wherein an outside circumferential wall of the base block defines a plurality of positioning grooves therein.

17. The hinge device as described in claim 16, wherein a center of the base block defines a through hole.

18. A foldable electronic device, comprising:
a cover comprising a first connector which is fixed on one side thereof;
a body comprising a second connector which is fixed on one side thereof; and
a hinge device interconnecting the cover and the body via the first and second connectors; wherein
the hinge device comprises a shaft, a sleeve, a spring, a driven block, a cam and a base block, a flange head is defined on one end of the shaft, the driven block comprises two protrusions protruding in opposite directions, the cam defines two opposite concave grooves and two opposite arms, the spring presses the driven block and the cam, interfaces of the driven block and the arms of the cam are plane surfaces, the shaft passes through the sleeve, the spring, the driven block, the cam and the base block in turn, and when the protrusions of the driven block are located on the plane surfaces, the hinge device is held in a steady state by the spring.

19. The foldable electronic device as described in claim 18, wherein a distal end section of said shaft defines a pinhole therein.

20. The foldable electronic device as described in claim 19, further comprising a pin received in the pinhole.
